(19) United States
(12) Patent Application Publication
(10) Pub. No.: US 2018/0008886 A1
(43) Pub. Date: Jan. 11, 2018

(54) TRAINING AND STIMULATION DEVICE

(71) Applicant: Pet-Pocket ApS, Aarhus C (DK)

(72) Inventor: Frank Nelson Espensen, Esbjerg (DK)

(73) Assignee: Pet-Pocket ApS, Aarhus C (DK)

(21) Appl. No.: 15/541,171

(22) PCT Filed: Jan. 8, 2016
(86) PCT No.: PCT/DK2016/050003

§ 371 Date: Jun. 30, 2017

(30) Foreign Application Priority Data
Jan. 9, 2015 (DK) PA 2015 00017

(51) Int. Cl. A63F 9/06; A63F 11/00; A01K 15/02

(52) U.S. Cl. CPC A63F 9/0601; A63F 9/0602; A01K 15/025; A63F 2250/022; A63F 2011/0079

(57) ABSTRACT

A device (2) for training and stimulation of dogs or children, which device (2) comprises a number of elements (6, 6′, 8, 8′, 74, 76, 78, 80, 88, 88′, 90, 90′) configured to be locked and thereby fix and at least partly hide a number of tidbits (4, 4′, 4″, 4″), wherein the device (2) has activation members (12, 12′, 12″, 12′″, 14, 16, 26) for opening/detachment of the elements (6, 6′, 8, 8′, 74, 76, 78, 80, 88, 88′, 90, 90′). The elements (6, 6′, 8, 8′, 74, 76, 78, 80, 88, 88′, 90, 90′) prevent one or more of the other elements (6, 6′, 8, 8′, 74, 76, 78, 80, 88, 88′, 90, 90′) from being opened/detached in such a manner that a first element (8′) is required to be opened/detached in order to open/detach another element (8).

### BACKGROUND OF THE INVENTION

### Field of the Invention

The present invention relates to a training and stimulation device for dogs or children. The present invention also relates to a training and stimulation device configured to activate and challenge dogs or children.

### Description of Related Art

Various types of training devices are used to mentally stimulate and train dogs. It is generally known that metal stimulation of a dog has a positive influence on the behaviour of the dog. Dog trainers, for several years, have been arguing that dogs need mental as well as physical stimulation. It is well known that dogs get easily bored and need something to occupy their time in order to keep them from turning destructive. Accordingly, several types of toys are readily available for a dog's mental pleasure.

The main challenge of the known types of dog toys is that the dog quickly gets familiar with the dog toy and becomes “tired” of the toy and loses interest in it. Moreover, several of the known types of dog toys are noisy, which is why the dog owner often throws the dog toy away shortly after buying it.

Therefore, it is desirable to provide an improved device for stimulating and training dogs and children, wherein the level of difficulty of the device can be increased.

It is further desirable to provide an improved device for stimulation and training of dogs, where the dog continuously is trained to choose new ways.

It is further desirable to provide a device for stimulating the motor skills and cognitive training of young children.

### SUMMARY OF THE INVENTION

It is an object of the present invention to provide an improved device for stimulating and training dogs and children, wherein the level of difficulty of the device can be increased.

It is further an object of the present invention to provide an improved device for stimulation and training of dogs, where the dog continuously is trained to choose new ways.

It is also an object of the present invention to provide a device for stimulating the motor skills and cognitive training of young children.

The objects of the present invention can be achieved by a device as described below and illustrated in the accompanying drawings.

The device according to the invention is a device for training and stimulation of dogs or children, which device comprises a number of elements configured to be locked and thereby fix and at least partly hide a number of tidbits, wherein the device comprises activation members for opening/detachment of the elements, wherein the device comprises

a) a number of elements that prevent one or more of the additional elements from being opened/detached in such a manner that a first element is required to be opened/detached in order to open/detach another element and/or

b) one or more attachment members configured to be separated into two pieces and to be joint to constitute one assembled attachment member, wherein the device comprises structures configured to engage with the one or more attachment members and/or

c) at least one displaceable member configured to be displaced relative to a stationary portion of the device, wherein there is access to the elements only when the displaceable member is displaced relative to the stationary portion of the device, wherein there is no access to the elements when the displaceable member maintains its resting configuration and/or

d) at least one collapsible member configured to be rolled up, wherein the collapsible member is rolled up in its resting configuration, wherein the collapsible member is configured to be unrolled and be maintained in a completely or partly unrolled configuration by applying a force of a predefined magnitude to the collapsible member, wherein there is only access to the elements when the collapsible member is in a completely or partly unrolled configuration, wherein there is no access to the elements, when the collapsible member is in its resting configuration.

Hereby, it is possible to provide an improved device for stimulating and training dogs and children, wherein the level of difficulty of the device can be increased. It is furthermore possible to provide an improved device for stimulation and training of dogs, where the dog continuously is trained to choose new ways. Moreover, it is possible to provide a device for stimulating the motor skills and cognitive training of young children.

Stimulation and training of dogs and children involves activating, teaching and behavioural therapy (to achieve adaptation). When it comes to dogs, the device according to the invention may advantageously be used to mentally as well as physically stimulate the dog in order to tire it for the purpose of avoiding the dog becoming destructive (biting and making sounds as bored unstimulated dogs often do).

The device may be used to train and stimulate the motor skills of children and train children's ability to recognize symbols (numbers and letters), geometric shapes and colors.

The elements configured to be locked and hereby fix and at least partly hide a number of tidbits may have any suitable size and shape. The elements may be formed as pieces of fabric, plastic or leather being mechanically attached (e.g., by stitching) to constitute a pocket-like structure in which one or more tidbits can be arranged and fixed.

The device comprises activation members for opening/detachment of the elements. These activation members may be formed in any suitable manner and may comprise bands, bores, holes, elastic bands, buttons, hook and loop fasteners, magnets (e.g., magnets integrated in fabric by means of stitching), zippers or other suitable means.

In one embodiment, the device comprises a number of elements that prevent one or more of the additional elements from being opened/detached in such a manner that a first element is required to be opened/detached in order to open/detach another element. Hereby, a “layer upon layer” or “lock upon lock” type structure is achieved. Accordingly, the dog or the child is required to solve several consecutive challenges/obstacles in order to have access to a reward in the form of a tidbit or another desirable piece that is attractive for dogs or children (e.g., a caramel) which may be wrapped in order to increase the effort it takes to get access to the tidbit or reward.

In a second embodiment, the device comprises one or more attachment members configured to be separated into two pieces and to be joint to constitute one assembled attachment member, wherein the device comprises structures configured to engage with the one or more attachment members

The attachment members may be cylindrical. The attachment members may be alternatively be arced (e.g., U-shaped) or have another geometric shape.

In a third embodiment, the device comprises at least one displaceable member configured to be displaced relative to a stationary portion of the device, wherein there is access to the elements only when the displaceable member is displaced relative to the stationary portion of the device, wherein there is no access to the elements when the displaceable member maintains its resting configuration.

Hereby, it is possible to pull out the displaceable member and subsequently have access to tidbits hidden e.g., under a pocket attached by means of hook and loop fasteners.

In a fourth embodiment, the device comprises at least one collapsible member configured to be rolled up, wherein the collapsible member is rolled up in its resting configuration, wherein the collapsible member is configured to be unrolled and be maintained in a completely or partly unrolled configuration by applying a force of a predefined magnitude to the collapsible member, wherein there is only access to the elements when the collapsible member is in a completely or partly unrolled configuration, wherein there is no access to the elements, when the collapsible member is in its resting configuration.

This embodiment enables challenging and instructive experiences for the dog or child using the device.

It may be an advantage that the device comprises a plurality of elements configured to be locked and hereby fix and at least partly hide a number of tidbits.

It may be an advantage that the elements comprise structures shaped as corresponding hook and loop fasteners. Hereby, an easy use (attachment and detachment) of the elements can be achieved. It is possible to provide a flexible and user-friendly device. Furthermore, it is easy for a dog or a child to recognize the sound of a correct opening of one of the locking mechanisms of the device.

It may be beneficial that the device comprises a plurality of elements that prevent one or more of the additional elements from being opened/detached in such a manner that a first element is required to be opened/detached in order to open/detach another element.

Hereby, a “layer upon layer” or “lock upon lock” type structure can be achieved. Therefore, the dog or the child must solve several consecutive challenges/obstacles in order to have access to a reward in the form of a tidbit or another desirable piece that is attractive for dogs or children (e.g., a caramel) which may be wrapped in order to increase the effort it takes to get access to the tidbit or reward.

It may be advantageous that the elements comprise attachment members shaped as corresponding button members. The corresponding button members may be press buttons or other suitable types of buttons.

It may be beneficial that a flap is provided in the distal end of the elements, wherein the flap has a shape that ensures that:

a) a dog is capable of biting and hereby holding onto the flap while pulling the flap or

b) a child is capable of gripping the flap and hereby holding on to the flap while pulling the flap.

The use of flaps makes it possible for dogs or children to get a hold on the structures that must be pulled in order to get access to the hidden tidbits.

The flaps may preferably have an easy recognizable color, such as yellow (dogs cannot see red and green).

It may be an advantage that the device comprises one or more attachment members formed from an edible material configured to be assembled to form a single attachment member, wherein the device comprises a structure configured to engage with the one or more attachment members.

Hereby, it is possible to sharpen the dog's interest for opening a locked structure comprising one of the said attachment members.

It may be an advantage that the attachment members are configured to be separated into two or more pieces after being assembled.

By assembling the attachment members, it is possible to provide several different complex structures.

It may be an advantage that the attachment member comprises a first portion and a second portion, wherein a central bore is provided in the first portion, wherein the second member is provided with an elongated connection member configured to be engagely received by the bore.

Hereby, it is possible to produce a user-friendly and easily producible attachment member.

It may be beneficial that the attachment member comprises a body portion, a barbed portion, preferably arranged in the distal end of the attachment member, wherein a hole is provided in the attachment member, wherein the barbed portion is configured to be received by the hole and be maintained attached to the hole. Hereby, an easy and reliable assembling of the attachment member can be achieved.

It may be advantageous that the body portion is flexible. Hereby, it is possible to bend the body portion of the attachment member in order to connect the two distal portions (ends) of the attachment member.

It may be beneficial that a pointed locking member is provided in the attachment member, preferably in the connection member or in the barbed portion. Hereby, the pointed end can easily be received by the hole.

It may be an advantage that the attachment member comprises one or more through-going bores configured to allow for ventilation. Hereby, the bore(s) provide the required ventilation in case that a dog swallows the attachment member and it gets stuck in the throat of the dog.

It may be beneficial that the device comprises a flexible member configured displace the displaceable member relative to the stationary portion of the device. Hereby, it is possible to provide a desired displacement in an easy and simple manner that ensures that the device returns to its resting position when no force is applied to extend the flexible member.

It may be beneficial that the device comprises a first element that needs to be opened/detached in order to allow a second element to be opened/detached.

It may be beneficial that the device comprises a first element that needs to be opened/detached in order to allow a second element to be opened/detached, wherein the first element basically extends perpendicular to the second element. Hereby, a direction specific challenge is provided, so that the dog is forced to adjust the pulling direction when detaching two subsequent overlap members.

It may be an advantage that the device comprises a flexible slide with stitched flaps (flap pockets).

It may be beneficial that the device comprises elements that are configured to enable that the device can be attached by means of an elastic member fixed to a hook attached to a ceiling.

It may be advantageous that the device comprises a number of fabric members that are partly or completely stitched together.

The device may preferably comprise structures made in a washable and durable fabric.

It may be beneficial that the device comprises a connection member configured to connect a first structure and/or a second structure, wherein the connection member comprises a first portion and a second portion and a central body member extending between the first portion and second portion, wherein the connection member is a single and separate structure, wherein the first portion and the second portion comprise an attachment structure configured to be attached to the first structure and/or the second structure, wherein the attachment structures comprise hook and/or loop fasteners, wherein the connection member comprises a flexible structure configured to allow the connection member to be extended and/or bent.

Hereby, it is possible to provide a device having a connection member that enables an easily removable attachment and allows for connecting separate structures independently of the relative orientation of and distance between the structures.

The connection member is configured to connect a first structure and/or a second structure. This is done by means of attachment structures formed as hook and/or loop fasteners provided at the first portion and the second portion. Accordingly, the connection member can be attached to corresponding attachment structures provided at the first structure and/or a second structure.

The first portion, the second portion and the central body portion may have any suitable shape. It is, however, preferred that the first portion, the second portion and the central body portion are relatively thin.

It may be an advantage that the first portion, the second portion and the central body portion are basically plate-shaped structures.

It may be beneficial that the first portion and the second portion are symmetric.

It may be an advantage that the central body member is an elongated member, e.g., having a basically rectangular geometry.

The connection member comprises a flexible structure configured to allow the connection member to be extended and/or bent. The flexible structure may be the connection member itself. This may be accomplished by providing the connection member in materials having sufficient flexibility for allowing the connection member to be extended and/or bent.

The flexible structure may be a separate structure, e.g., provided between the first portion and the second portion allowing the connection member to be extended and/or bent.

The flexible structure may be a rubber band or another flexible structure extending a separate element between the first portion and the second portion thus allowing the first portion and the second portion of the connection member to be displaced.

It may be advantageous that the connection member comprises a top surface provided with one or more attachment structures. Hereby, the top surface (the upper most surface of the connection member) can be attached to a structure, e.g., another connection member or a structure configured to receive the attachment members of the connection member.

It may be beneficial that the connection member comprises a bottom surface provided with one or more attachment structures. Hereby, the bottom surface (the lower most surface of the connection member) can be attached to a structure, e.g., another connection member or a structure configured to receive the attachment members of the connection member.

In one embodiment according to the invention, the connection member comprises a top surface provided with one or more attachment structures and a bottom surface provided with one or more attachment structures. Hereby, the top surface and the bottom surface can be attached to structures, e.g., other connection members or structures configured to receive the attachment members of the connection member.

It may be an advantage that the connection member comprises several attachment structures of different types. Hereby, it is possible to attach the connection member to structures provided with different types of attachment structures.

It may be advantageous that the connection member comprises several attachment structures of similar types. Hereby, the connection member may be attached to several attachments areas provided with the same type of attachment structures.

It may be an advantage that the connection member is provided with at least one attachment free area. Hereby, the removal of the connection member can be eased. The attachment free area may be provided in different positions.

It may be beneficial that the connection member is provided with a central attachment free area. Hereby, it is possible to position an object, e.g., a tidbit in the attachment free area and use the connection member to fix the tidbit (arranged between the connection member and the underlying structure) to a structure by means of the connection member.

It may be advantageous that the connection member is provided with an attachment free area provided at the first portion or at the second portion. It may be beneficial that the attachment free area is provided at the periphery of the first portion or at the second portion. Hereby, it is possible to get hold of the connection member by means of the attachment free areas when the connection member is attached to an underlying structure.

It may be beneficial that the first portion and second portion are shaped as flat structures having basically constant thickness. Hereby, the user-friendliness of the connection member is increased. Furthermore, it is easy to produce a connection member having basically constant thickness. The connection member may be produced out of leather or a fabric provided with attachment structures comprising hook and loop fasteners.

It may be an advantage that the connection member comprises a central body portion extending between a first body portion and a second body portion, wherein the width of the first body portion and the width of the second body portion is larger than the width of the central body portion.

It may be advantageous that the first portion is attached to the second portion by means of a flexible member. Hereby, the flexible member enables the first portion and the second portion of the connection member to be displaced. Moreover, the flexible member enables the first portion and the second portion of the connection member to be rotated.

It may be an advantage that the flexible member is a rubber band.

The invention will become more fully understood from the detailed description given herein below. The accompanying drawings are given by way of illustration only, and thus, they are not limitative of the present invention.

### BRIEF DESCRIPTION OF THE DRAWINGS

FIG. 1A shows a schematic illustration of a device according to the invention;

FIG. 1B shows a schematic illustration of the device shown in FIG. 1A in an open configuration;

FIG. 1C shows a schematic illustration of an attachment member configured to be used in a device according to the invention in cross section;

FIG. 1D shows a schematic illustration of the attachment member shown in FIG. 1C while being opened;

FIG. 1E shows a schematic illustration of the attachment member shown in FIGS. 1C and 1n FIG. 1D in an open configuration;

FIG. 2A shows a schematic illustration of an attachment member configured to be used in a device according to the invention, in a closed configuration;

FIG. 2B shows a schematic side view of an attachment member shown in FIG. 2A in an open configuration;

FIG. 2C shows a schematic illustration of the attachment member configured to be used in a device according to the invention, in a closed configuration;

FIG. 2D shows a top view of the attachment member shown in FIG. 2C;

FIG. 2E shows the attachment member shown in FIG. 2C and FIG. 2D in a semi-open configuration;

FIG. 3A shows a schematic illustration of an attachment member according to an embodiment of the invention;

FIG. 3B shows a schematic cross-sectional view of an attachment member in a separated configuration;

FIG. 3C shows a schematic cross-sectional view of the attachment member shown in FIG. 3B while being assembled;

FIG. 3D shows a schematic cross-sectional view of the attachment member shown in FIG. 3B and FIG. 3C in an assembled configuration;

FIG. 3E shows an side view (seen from the end) of the attachment member shown in FIG. 3B, FIG. 3C and FIG. 3D;

FIG. 3F shows a schematic view of the attachment member shown in FIG. 3A while being used;

FIG. 3G shows a schematic view of the attachment member shown in FIG. 3A;

FIGS. 3H & 31 show an attachment member;

FIG. 4A is a schematic view of a device according to the invention in a closed configuration;

FIG. 4B is a schematic view of the attachment member shown in FIG. 4A in another configuration;

FIG. 4C is a schematic view of the device shown in FIG. 4A in a third configuration;

FIG. 5A shows a schematic view of the device shown in FIG. 4A in a fourth configuration;

FIG. 5B shows a schematic view of the device shown in FIG. 4A in a fifth configuration;

FIG. 5C shows a schematic view of the device shown in FIG. 4A in a sixth configuration;

FIGS. 6A-6G shows a device with a structure comprising a basically square plate-shaped member;

FIG. 7A shows a schematic view of a device according to the invention in a first configuration;

FIG. 7B shows a schematic view of the device shown in FIG. 7A in a more open configuration;

FIG. 7C shows a schematic view of the device shown in FIG. 7A and FIG. 7B in an even more open configuration;

FIG. 8A shows a schematic view of a device according to the invention in a first closed configuration;

FIG. 8B shows a schematic view of the device shown in FIG. 8A in a second more open configuration;

FIG. 8C shows a schematic view of the device shown in FIG. 8A and FIG. 8B in a third even more open configuration;

FIG. 9A shows a schematic view of the a device according to the invention in a first rolled up configuration;

FIG. 9B shows a side view of the device shown in FIG. 9A;

FIG. 9C shows a top view of the device shown in FIG. 9B;

FIG. 9D shows a close-up view of how a tidbit can be placed in the pocket in the bottom section;

FIG. 10A is a schematic top view of a connection member according to the invention;

FIG. 10B is a schematic top view of a connection member according to the invention showing the way it is constructed;

FIG. 10C shows a top view of a partitioned connection member according to the invention in a closed configuration;

FIG. 10D shows a top view of the partitioned connection member shown in FIG. 2A in an open configuration;

FIG. 10E shows five connection members arranged on top of each other;

FIG. 11A shows a connection member provided with an attachment free corner area;

FIG. 11B shows a connection member provided with two attachment free corner areas and a central attachment free area;

FIG. 11C shows a connection member provided with a central attachment free area;

FIG. 11D shows the opposite side of the connection member shown in FIG. 3A;

FIG. 11E shows the opposite side of the connection member shown in FIG. 3B;

FIG. 11F shows another connection member according to the invention;

FIG. 12A shows how two structures are connected by means of a connection member according to the invention;

FIG. 12B shows how three structures are connected by means of connection members according to the invention;

FIG. 12C is a cross-sectional view of a connection member according to the invention;

FIG. 12D is a cross-sectional view of the connection member shown in FIG. 4C in another configuration;

FIG. 13A is a cross-sectional view of a connection member according to the invention being attached to an underlying structure;

FIG. 13B is a cross-sectional view of a connection member attached to an underlying structure;

FIG. 13C is a top view of a connection member attached to an underlying structure;

FIG. 13D is a top view of a connection member attached to a first structure and another connection member connecting the first structure and a second structure;

FIG. 14A shows a connection member divided into a first portion and a second portion;

FIG. 14B shows a perspective view of a connection member according to the invention;

FIG. 14C shows a connection member provided with attachment free areas;

FIG. 14D shows a connection member having a first portion and a second portion connected by a flexible member;

FIG. 14E shows a connection member provided with a central attachment free area;

FIG. 14F shows a connection member having a first portion and a second portion connected by a flexible member;

FIG. 14G shows a connection member divided into a first portion and a second portion;

FIG. 15A is a perspective view of a rectangular fabric divided into three equal sized areas;

FIG. 15B is a perspective view of the fabric shown in FIG. 15A in a configuration in which the third area is folded;

FIG. 15C is a perspective view of the fabric shown in FIG. 15B in a configuration in which the third area III and the second area II are folded;

FIG. 15D is a schematic view of a training device made out of the sections shown in FIG. 15C;

FIG. 15E shows the sections put together to constitute a training device shaped as a compact and closed member;

FIG. 15F shows a first connection member and a second connection member attached to the training device to keep it locked and

FIG. 15G is a perspective view of the training device shown in FIG. 15D, FIG. 15E and FIG. 15F.

### DETAILED DESCRIPTION OF THE INVENTION

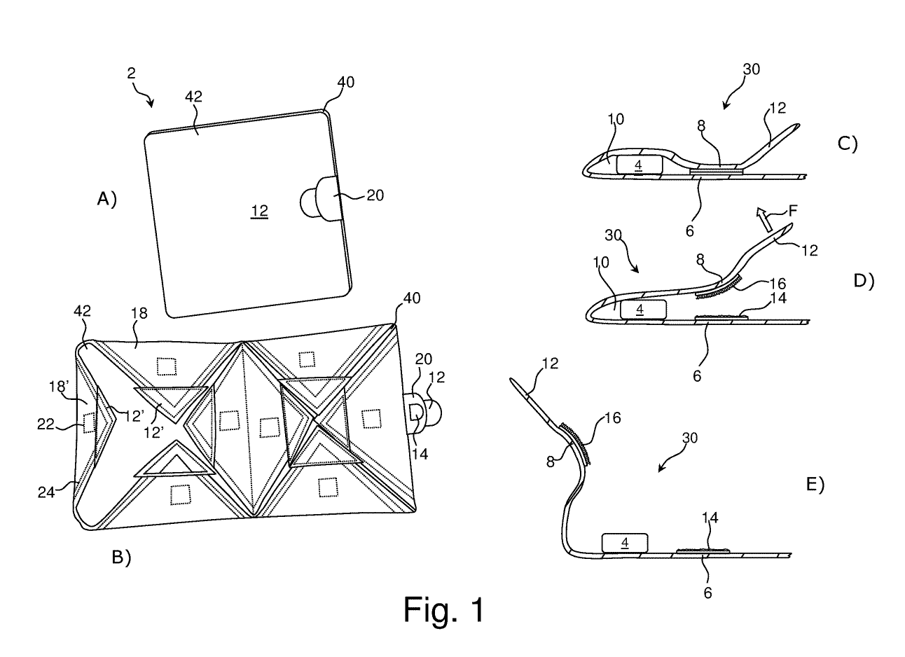

Referring now in detail to the drawings for the purpose of illustrating preferred embodiments of the present invention, a device 2 of the present invention is illustrated in FIG. 1A.

FIGS. 1A-E show schematic illustrations of a device 2 according to the invention. The device 2 shown in FIG. 1A is in a closed configuration and comprises a first portion 40 and a second portion 42 that are rotatably attached to each other by means of a centrally arranged transversal stitching (see FIG. 1B).

A superjacent member 20 is attached to the first portion 40. The superjacent member 20 may preferably be attached to the first portion 40 by stitches. At the same time, in the configuration shown in FIG. 1A, the superjacent member 20 is attached to the second portion 42 by means of a flap 12 comprising attachment means (hook and loop fasteners) configured to be attached to the second portion 42.

A flap 12 is attached to the distal portion of the superjacent member 20. In the configuration shown in FIG. 1A, the superjacent member 20 is detachably attached to the second portion 42, whereas the superjacent member 20 is detached from the second portion 42 in the configuration shown in FIG. 1B.

FIG. 1B shows the device 2 shown in FIG. 1A in an open configuration. The device 2 comprises eight pockets 18, 18′. Four pockets 18, 18′ are provided at the first portion 40 and four pockets 18, 18′ are provided at the second portion 42. The pockets 18, 18′ are configured to be opened by pulling the flap 12′, 12″ that is provided in the distal portion of the pockets 18, 18′.

The pocket 18′ closest to the left side in FIG. 1B has been partly opened. This pocket 18′ is configured to be opened by pulling the flap 12′ and hereby bringing the pocket 18′ out of engagement/attachment with the underlying structure. Stitching/hems 22, 24 are indicated. The stitching/hem 22 indicates the area at which the attachment member (e.g., loop and hook fasteners or a button that is not shown) is arranged at the bottom side of the pocket 18′. Accordingly, the pocket 18′ is configured to be opened by pulling the flap.

The first portion 40 and second portion are preferably made of a fabric configured to be provided with stitching/hems. The fabric may preferably be wear-resistant so that the device 2 is suitable for stimulation and training of dogs and to train the motor skills and cognitive skills of children.

It is possible to arrange one or more tidbits (not shown) in each pocket 18, 18′. Accordingly, it is possible for a dog to smell the tidbit(s) and hereby locate the position of the titbit. Therefore, the dog will try to get access to the tidbit(s).

The device 2 is constructed in such a manner that access to the tidbits requires a preceding pulling of the first flap 12, in order to open the device 2 (as shown in FIG. 1B), and that subsequent pulling of one or more flaps 12′, 12″ is required in order to get access to the tidbit(s). Accordingly, the device is highly suitable for stimulation and training of dogs in a manner in which the level of difficulty can be increased.

Initially, it is possible to arrange a tidbit in such a manner, that it is accessible for the dog, when the first flap 12 is pulled away from the second portion 42, so that the device 2 can be opened.

When the dog has learned to do this, it is possible to hide tidbits in one or more of the additional pockets 18, 18′. Accordingly, the dog first needs to open the device 2 by pulling the first flap 12 and then open a pocket 18, 18′, in which the tidbit is hidden.

FIG. 1C shows a schematic illustration of an attachment member 30 configured to be used in a device according the invention. The attachment member 30 is shown in a closed configuration in FIG. 1C. The attachment member 30 comprises a bottom portion 6 that is attached to a top portion 8. A space 10 is provided between the top portion 8 and the bottom portion 6. In this space 10, a tidbit 4 is arranged. The tidbit 4 is restricted from being removed from the space 10 as long as the top portion 8 is attached to the bottom portion. Accordingly, the tidbit 4 is hidden and not accessible, unless the top portion 8 is pulled away from the bottom portion 6.

The top portion 8 can be pulled away from the bottom portion 6 by pulling the flap 12 constituting the distal (free) portion of the top portion 8.

FIG. 1D shows a schematic illustration of the attachment member 30 shown in FIG. 1C while the attachment member 30 is being opened.

The pulling of the flap 12 is indicated by an arrow that indicates the applied force F. By pulling the male part 16, it is released from the female part 14. The male part 16 and the female part 14 are corresponding loop and hook fasteners configured to attach the top portion 8 to the bottom portion 6.

By removing the male part 16 from the female part 14 (by pulling the flap 12), an opening to the space 10 is created.

FIG. 1E shows a schematic illustration of the attachment member 30 shown in FIG. 1C and FIG. 1D in an open configuration. The top portion 8 is removed from the bottom portion 6 and therefore there is access to the tidbit 4.

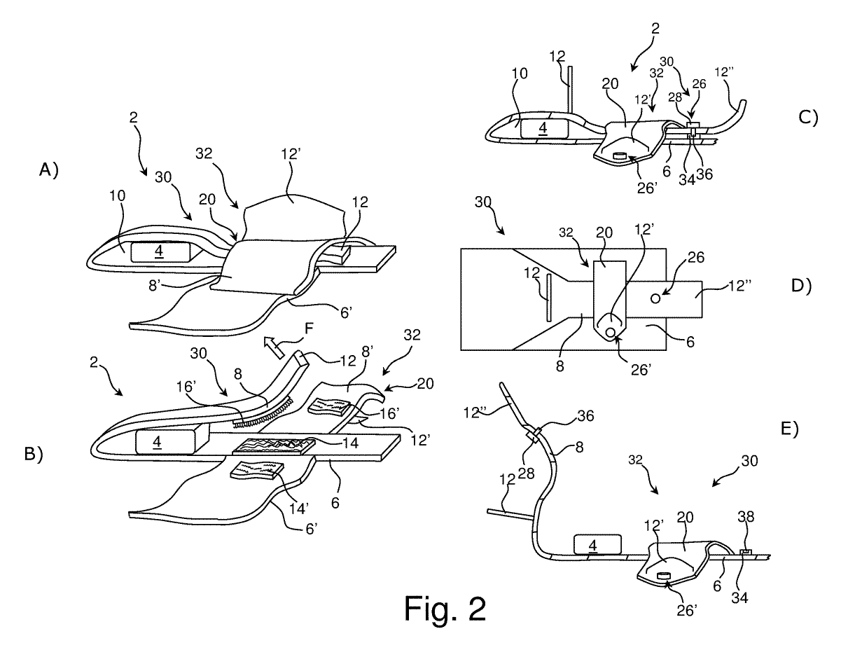

FIG. 2 shows two schematic illustrations of a first attachment member 30 and a second attachment member 32 configured to be used in a device 2 according to the invention. The attachment members 30, 32 are shown in a closed configuration in FIG. 2A and in an open configuration in FIG. 2B.

The first attachment member 30 comprises a bottom portion 6 and a top portion 8. The bottom portion 6 is provided with a first attachment member 14 shaped as a loops and hooks fastener (female part), whereas a corresponding attachment member 16 shaped as a loops and hooks fastener (male part) is attached to the top portion 8.

Likewise, the second attachment member 32 comprises a bottom portion 6′, onto which a first attachment member 14′ is attached. The first attachment member 14′ is shaped as a loop and hook fastener (female part). The second attachment member 32 comprises a top portion 8′ provided with an attachment member 16′ and is shaped as a loop and hook fastener (male part) configured to engage with the first attachment member 14′.

In FIG. 2A, the attachment members 14, 14′, 16, 16′ are attached to each other. The top portion 8 is attached to the bottom portion 6, whereas the top portion 8′ is attached to the bottom portion 6′. The top portion 8′ also constitutes a superjacent element 20.

In FIG. 2B, the attachment member s 14, 14′, 16, 16′ are no longer attached to each other. Therefore, the top portion 8 is no longer attached to the bottom portion 6 and the top portion 8′ is no longer attached to the bottom portion 6′ as in FIG. 2A.

In FIG. 2B, it can be seen that a space for fixedly arranging a tidbit 4 is provided between the top portion 8 and the bottom portion 6. Furthermore, it can be seen that by pulling the flap 12 an opening will be created in the space. The attachment members 14, 16 are brought out of engagement by applying a force F as indicated with the arrow in FIG. 2B. By pulling the flap 12′, it is possible to loosen the second attachment member 32 shown in FIG. 2A. Accordingly, the top portion 8′ will be separated from the bottom portion 6′, as shown in FIG. 2B.

The device 2 is suitable for stimulating and training of dogs. It is possible to hide a tidbit in such a manner that it is only accessible for a dog when the dog has separated the top portion 8′ from the bottom portion 6′ and the top portion 8 from the bottom portion 6, by pulling the first flap 12′ and subsequently pulling the second flap 12.

FIG. 2C-E. show schematic illustrations of a first attachment member 30 and a second attachment member 32 configured to be used in a device according to the invention. FIG. C-E schematically illustrate how the shown attachment member 30, 32 can be applied.

FIG. 2C shows a cross-sectional view of a device 2 according to the invention in a closed configuration. FIG. 2D illustrates a top view, while FIG. 2E shows a cross-sectional side view of a partly open configuration.

The device 2 comprises an attachment member 32 having a bottom portion 6, wherein a superjacent element 20 is configured to be attached by means of a push button 26′. A flap 12′ is configured to allow the connection between the portions of the button 26′ to be detached from each other, in order to release the bottom portion 6 from the superjacent element 20.

The device 2 moreover comprises an attachment member 30 configured to attach the top portion 8 to the bottom portion 6 by means of a push button 26 having a button member 26 equipped with an engagement member 36 (male part) and a corresponding engagement member (female part) 38. A flap 12″ is provided in the distal end of the top portion 8.

In FIG. 2C, a space 10 is provided between the top portion 8 and the bottom portion 6. A tidbit 4 is arranged in this space 10. A flap 12 is attached to the top side of the top portion 8. The button 26 is closed so that the two engagement members 36, 38 are brought into engagement with each other. The attachment member 32 is configured to be opened by pulling the flap 12′.

FIG. 2D shows a top view of the attachment member 30 shown in FIG. 30. It can be seen that the bottom portion 6 is wider than the top portion 8 and the superjacent element 20. Both buttons 26, 26′ are attached to the underlying bottom portion 6. Accordingly, there is no access to the tidbit 4 (see FIG. 2C).

By pulling the flap 12′, the flap 12″ can subsequently be accessed and pulled in order to get access to the tidbit 4. On the other hand, it is possible to pull the flap 12″ and thereby release the top portion 8 from the bottom portion 6 and subsequently pull the distal portion of the top portion 8 out of the superjacent element 20 by pulling the flap 12′ like shown in FIG. 2E. Hereby, access to the tidbit 4 is achieved.

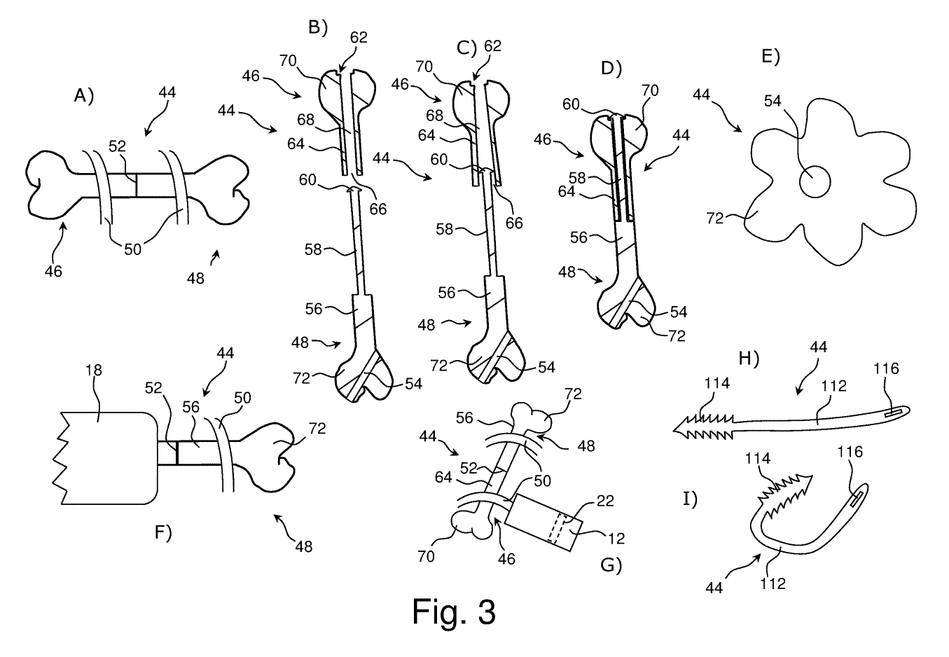

It is possible to replace the buttons 26, 26′ by hook and loop fasteners of attachment members as shown in FIGS. 3A-F which show schematic illustrations of an attachment member 44 according to the invention.

FIG. 3A shows a schematic illustration of an attachment member 44 configured to be used in a device according to the invention. The attachment member 44 is shaped as an eatable dog bone comprising a first portion 46 to which a second portion 48 is attached.

The two portions 46, 48 are connected in a joint 52. The attachment member 44 is arranged under two bands 50.

FIG. 3B shows a schematic cross-sectional view of an attachment member 44 according to the invention in a separated configuration. The attachment member 44 comprises a first portion 44 with a head 70 and a longitudinal portion 64 as well as a second portion 48 having a head 72 and a longitudinal portion 56. A through-going bore 68 is provided in the first portion 46. The bore comprises an opening 66 provided in the end of the longitudinal portion 64 and a cavity 62 provided in the other end. The cavity is configured to receive a corresponding locking member 60.

The second portion 48 comprises a head 72 and a longitudinal portion 56 attached thereto. An elongated (rod-shaped) connection member 58 extends from the longitudinal portion 56. A pointed locking member 60 is provided in the end of the connection member 58.

A through-going bore 54 is provided in the second portion 48. This bore 54 is configured to vent the dog bone in case that the dog bone gets stuck in the throat of a dog. Accordingly, the dog will be able to breathe, even though the attachment member (the dog bone) gets stuck in the throat of the dog.

FIG. 3C shows a schematic cross-sectional view of the attachment member 44 shown in FIG. 3B being assembled. The locking member 60 has been inserted through the opening 66 in the bore 68. This causes the longitudinal portion 64 to expand (widen).

FIG. 3D shows a schematic cross-sectional view of the attachment member 44 shown in FIG. 3B and in FIG. 3C in an assembled configuration. The locking member 60 has been inserted through the opening 66 in the bore 68. The locking member 60 is brought into engagement with the cavity 62 that comprises a contact surface that constitutes a fixed support for the locking member 60. Accordingly, the locking member 60 is prevented from being pulled back through the bore 68.

FIG. 3E illustrates a side view of the attachment member 44 shown in FIG. 3B, FIG. 3C and FIG. 3D. The attachment member 44 is shaped as a schematic flower in order to provide air canals that provide access to air (like the bore 54) in case the attachment member 44 gets stuck in the throat.

The attachment member 44 is preferably made in a resilient or soft material allowing the longitudinal portion 64 to expand (widen), when the locking member 60 is forced into the opening 66 in the bore 68. The attachment member 44 may comprise a longitudinal wedge-shaped recess extending from the locking member 60 to the connecting member 68. Accordingly, the connection member 58 will provide the required flexibility and compressibility in order to allow it to be pressed through the bore 68.

FIG. 3F shows a schematic view of the attachment member 44 shown in FIG. 3A, however in another situation. The attachment member 44 is applied to connect/fix a pocket 18 and a band 50. A dog using the device provided with this attachment member 44, has to bite the attachment member 44 (made as a dog bone) into two pieces in order to get access to the underlying structure.

The attachment member 44 comprises a second portion 48 comprising a head 72 and a longitudinal portion 56 as well as a first portion with a longitudinal portion 52 that bears against the longitudinal portion 56, whereby the joint 52 is provided.

FIG. 3G shows a schematic illustration of an alternative manner of applying the attachment member 44 shown in FIG. 3A. FIGS. 3H and 31 illustrate an attachment member 44 with a body portion 112 that comprises a barbed portion 114 and a hole 116 similar to conventional ties used, e.g., to close trash bags.

The attachment member 44 is shaped as a dog bone comprising a first portion 46 having a head 70 to which a longitudinal portion 64 is attached. The attachment member 44 moreover comprises a second portion 48 having a head 72 comprising a longitudinal portion 56 attached to the head 72.

The first portion 46 and the second portion 48 are attached to each other. The two portions 46, 48 are connected in a joint 52. The attachment member 44 is provided below bands 50 of which the one is attached to an underlying material (not shown) by means of hook and loop fasteners (not shown) attached to the superjacent element 20 by means of a stitching/hem and a flap 12. The flap 12 is configured to detach the hook and loop piece (not shown) from the underlying matching portion by pulling the flap 12.

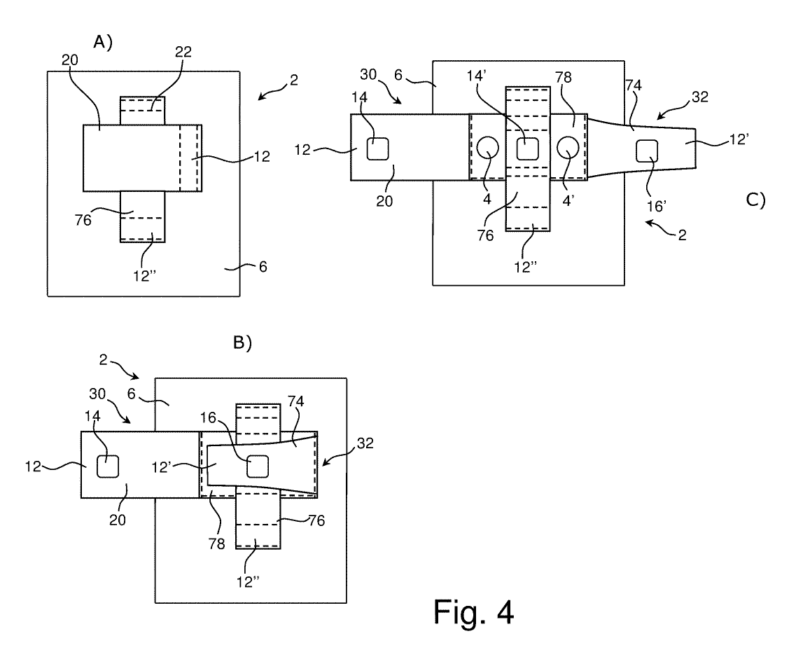

FIG. 4A shows a schematic illustration of a device 2 according to the invention in a closed configuration. The device 2 that may be made in fabric, comprises a rectangular bottom portion 6 to which a rectangular superjacent element 20 is attached. The stitching/hem 22 is indicated with dotted lines. The superjacent element 20 is arranged on the top of the underlying rectangular overlap member 76. A flap 12′ is provided in the distal end of the overlap member 76.

FIG. 4B shows a schematic illustration of a device 2 shown in FIG. 4A in another configuration. In the configuration shown in FIG. 4B, the superjacent element 20 has been removed from the underlying overlap member 74. A first attachment member 14 is attached to the bottom side of the superjacent element 20. A corresponding attachment member 16 is attached to the top side of the underlying overlap member 74. The superjacent element 20, the first attachment member 14 and the second attachment member 16 constitute a first attachment structure 30 (attachment member). The underlying overlap member 74 together with the superjacent attachment members (14′, 16′ shown in FIG. 4C) constitutes a second attachment structure 32 (attachment member).

The attachment members 14, 14′, 16, 16′ may preferably comprise loop and hook fasteners. Alternatively, it is possible to apply buttons or other suitable attachment members.

An underlying overlap member 78 is provided below the underlying overlap member 74 as well as the overlap member 76. The overlap member 74 comprises a flap 12′. Upon pulling the flap 12′, the overlap member 74 is released from the underlying overlap member 76.

FIG. 4C shows a schematic illustration of the device 2 shown in FIG. 4A in a third configuration. In this configuration, the flap 12′ has been pulled. Accordingly, the attachment members 14′, 16′ are released from each other. The attachment members 14′, 16′ are made as corresponding loop and hook fasteners.

Since the two attachment structures 30, 32 attached to one another have been removed, there is free access to the two tidbits 4, 4′ that are provided on the top surface of the overlap member 78.

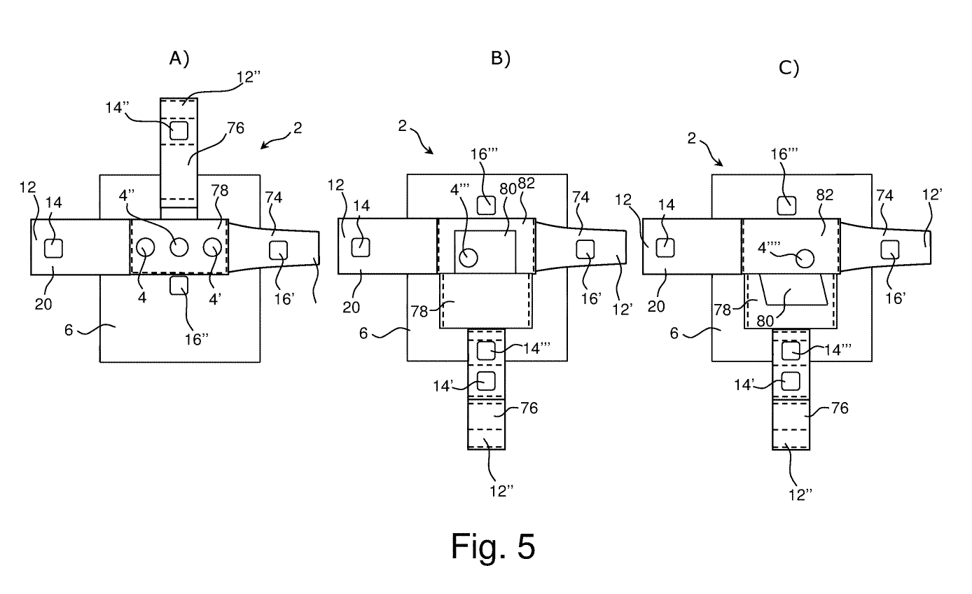

FIGS. 5A-C shows a schematic view of the device 2 shown in FIG. 4A in a fourth configuration in which the flap 12″ has been pulled in such a manner that the attachment members 14″, 16″ (attached to the overlap member 76 and the bottom portion 6, respectively) are released from each other. Hereby, access to the tidbit 4 is created.

FIG. 5B shows a schematic view of the device 2 shown in FIG. 4A in a fifth configuration in which the overlap member 78 has been bent away from the underlying overlap member 80 and a bottom portion 82 arranged thereunder. It is possible to get from the configuration shown in FIG. 4A to the configuration shown in FIG. 4B by pulling the flap 12″ and thereby removing the attachment member 14′″ from the corresponding attachment member 16″. Accordingly, access is provided to the tidbit 4′″.

FIG. 5C illustrates a schematic view of the device 2 shown in FIG. 4A, in a sixth configuration, in which the overlap member 80 has been bent back in order to get access to the tidbit 4′″.

The device 2 shown in FIG. 4-5 exemplifies how the invention makes it possible to hide tidbits 4, 4′, 4″, 4′″, 4″″ in the device in such a manner that a dog is extremely stimulated and challenged.

The dog initially needs to get a hold on the flap 12, pull the superjacent element 20 to release it from the underlying structure (the overlap member 74). Hereafter, the dog needs to get hold of the flap 12′ and pull the flap 12′ in order to release the overlap member 74 from the overlap member 76.

Accordingly, the device can be used to training, challenging and cognitively stimulating the dog. This process makes the dog tired. Therefore, the dog will subsequently have a calm and relaxed demeanor. The device 2 comprises a number of hiding places so large that the dog is capable of using the device in a very long time period and still be stimulated extensively.

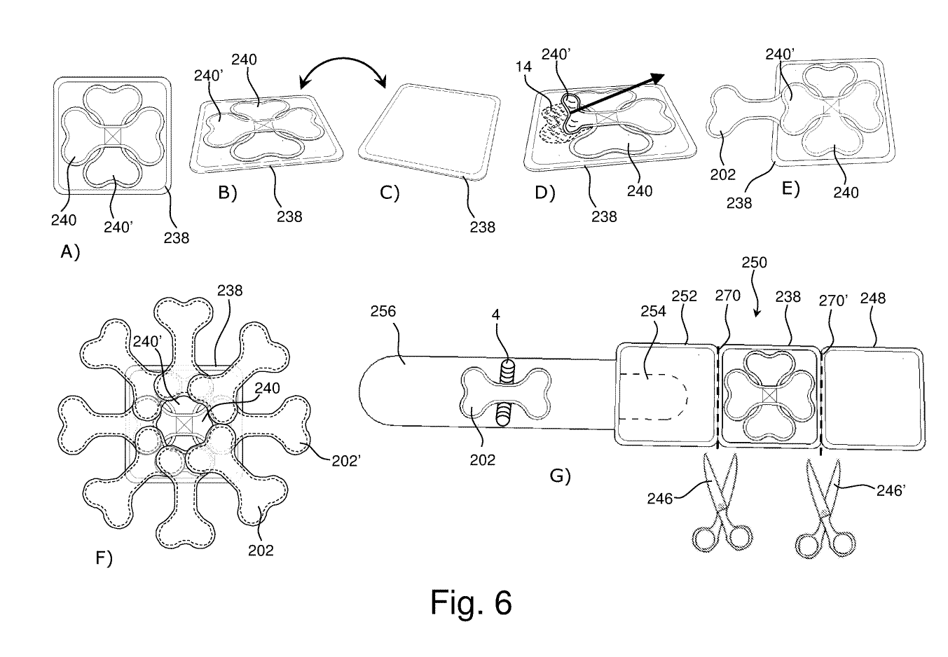

FIG. 6A illustrates a structure 238 that comprises a basically square plate-shaped member. A first fixed connection member 240′ has been stitched onto the structure 238. A second fixed connection member 240 has been stitched onto the first structure 238 and the first fixed connection member 240′. The distal portion of the fixed connection member 240 can be removed from the plate member by pulling the distal portion of the fixed connection member 240 as illustrated in FIG. 6D. The plate member and the backside of the fixed connection members 240, 240′ are made of hook and loop fasteners of matching type in order to provide a detachable attachment of the plate member and the backside of the fixed connection members 240, 240′.

FIG. 6B illustrates a perspective view of the structure 238 shown in FIG. 6A. FIG. 6C illustrates a perspective view of the backside of a structure 238 according to one embodiment of the invention. Please note that the structure 238 may have a flat backside as shown in FIG. 6C and that the structure 238 alternatively may have a backside as shown in FIG. 6A and in FIG. 6B. A fabric such as a fabric food wrap may be provided under the fixed connection members 240, 240′. Hereby, it is possible to use the structure 238 for placing food such as dog food.

FIG. 6D illustrates a perspective view of the structure 238 shown in FIG. 6A. The structure 238 comprises an essentially square plate-shaped member. A first fixed connection member 240′ has been stitched onto the structure 238. A second fixed connection member 240 has been stitched onto the first structure 238 and the first fixed connection member 240′. The distal portion of the fixed connection member 240 has been removed from the plate member by pulling the distal portion of the fixed connection member 240 in the direction indicated by the arrow. The backside of the fixed connection member 240′ is provided with an attachment member configured to engage with the attachment member 14 provided on the surface under the fixed connection member 240′. Hereby, the distal portions of the fixed connection member 240′ can be detachably attached to the plate-shaped member. The same construction is used to detachably attach the distal portion of the other fixed connection member 240 to the plate-shaped member.

FIG. 6E illustrates a top view of the structure 238 shown in FIG. 6D in a configuration in which a connection member 202 has been detachably attached to the attachment member 14 (see, FIG. 6D) provided on the top surface of the plate-shaped member under the fixed connection member 240′. The fixed connection member 240′ has further been attached to the backside of the fixed connection member 240′.

FIG. 6F illustrates a top view of a structure 238 as the one shown in FIG. 6A, FIG. 6B, FIG. 6D and FIG. 6E. A plurality of connection members 202, 202′ have been detachably attached to the top surface of the plate-shaped member under the fixed connection members 240, 240′. As illustrated in FIG. 6F the connection members 202, 202′ can be attached in several positions, including positions in which the fixed connection members 202, 202′ are attached to two fixed connection members 240, 240′ at the same time. The fixed connection members 240, 240′ are arranged in such a manner that the connection members 202, 202′ can be detachably attached in a plurality of ways as indicated in FIG. 6F.

FIG. 6G illustrates a perspective view of a training device 250. The training device 250 comprises a first portion shaped as a flat elongated member 256 made in fabric and a second portion comprising a first structure 252 attached to the flat elongated member 256, a second structure 238 corresponding to the structure shown in FIG. 6A and a third plate-shaped structure 248 attached to the distal end of the second structure 238.

A tidbit 4 is attached to the flat elongated member 256 by means of a connection member 202. The connection member 202 can be attached directly to the surface of the flat elongated member 256 because the backside of the connection member 202 and the surface of the flat elongated member 256 are covered with corresponding hook and loop fasteners.

A pocket 254 is provided in the first structure 252. The pocket 254 is indicated with a dotted line provided under the top surface of the first structure 252. A first cutting line 270 is indicated at the joint area between the first structure 252 and the second structure 238. Likewise, a second cutting line 270′ is indicated at the joint area between the second structure 238 and the third structure 248.

The training device 250 is designed for training and stimulation of dogs. The dog will try to get access to tidbits hidden under the fixed connection members of the second structure 238. Initially, the dog may place one paw at the first structure 252 and another paw on the third structure 248. Hereby, the dog is able to have a good grip on the training device 250. This will ease the process of finding hidden tidbits. When the dog has practised this task, the level of difficulty of the training device 250 can be increased by removing the third plate-shaped structure 248 by using scissors 246′ to cut along the cutting line 270′ as indicated. Likewise, the level of difficulty of the training device 250 can be increased by removing the first plate-shaped structure 252 by using the scissors 246 to cut along the cutting line 270.

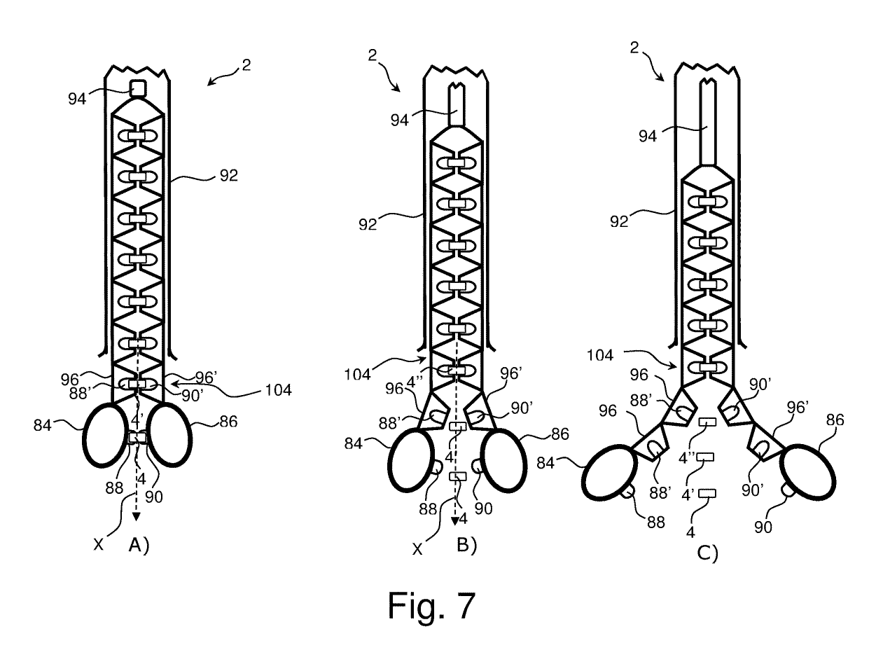

FIG. 7 shows a schematic view of the device 2 according to the invention in a first configuration in which the majority of the device 2 is arranged in a tubular sleeve 92. The device 2 comprises a number of frame members 96 provided in the left side and a corresponding number of frame members 96′ provided in the right side. Between each pair of frame members 96, 96′ a tidbit 4, 4′ is arranged in pocket members 88, 88′, 90, 90′ arranged to receive the tidbits 4, 4′. The frame members 96, 96′, the pocket members 88, 88′, 90, 90′ and the rings 84, 86 together constitute a displaceable member 104.

The device 2 moreover comprises a first ring 84 and a second ring 86. These rings 84, 86 are configured so that a dog can access the rings 84, 86 with the front paws (one paw in each ring 84, 86) and pull the rings 84, 86 in a direction parallel to the longitudinal axis X.

In the first configuration shown i FIG. 7A, all tidbits 4, 4′, 4″ are hidden in the pocket members 88, 88′, 90, 90′, and the rings 84, 86 are pulled slightly in a direction parallel to the longitudinal axis X of the device 2. Accordingly, the displaceable member 104 has been displaced along the longitudinal axis X by extending the flexible member 94.

In the configuration shown in FIG. 7B, the rings 84, 86 are pulled further along the longitudinal axis X of the device. This is possible because the flexible member 94 is resilient/flexible and thereby is extendable. Besides, the rings 84, 86 are separated further from each other (along the direction perpendicular to the longitudinal axis X), whereby the two tidbits 4, 4′ no longer are fixed in the pocket members 88, 88′, 90, 90′.

In the configuration shown in FIG. 7C, the rings 84, 86 are pulled even further along the longitudinal axis X of the device and separated from each other. Accordingly, the displaceable member 104 is displaced along the longitudinal axis X of the device. During this process, a further tidbit 4″ is released. The flexible member 94 is extended significantly more than in the configurations shown in FIG. 7A, and in FIG. 7B.

It is possible to challenge and stimulate a dog extensively by using a device as shown in FIG. 7. The dog needs to place its paws in the rings 84, 86 and hereafter the dog has to pull its paws towards its body. This movement stimulates the digging movement of the dog, however at the same time the dog needs to increase the distance between the rings (in a direction perpendicular to the longitudinal axis X of the device).

The one end (the end opposite to the rings 84, 86) of the sleeve 92 of the device needs to be fixed so that only the interior portion of the device 2 is displaced, when the dog pulls the rings 84, 86.

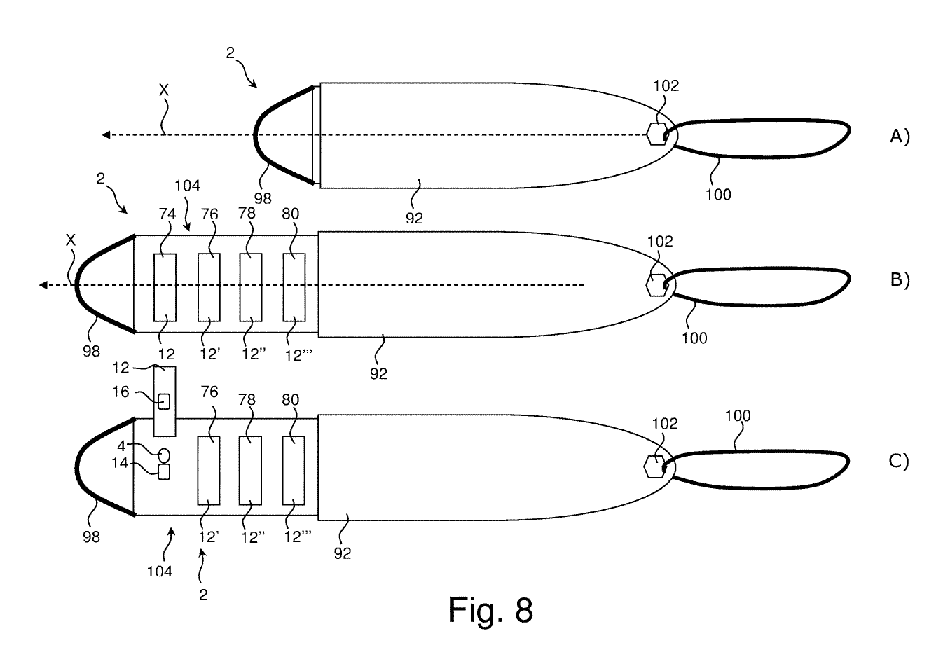

FIG. 8A shows a schematic view of a device 2 according to the invention in a first closed configuration. The device 2 comprises a basically tubular sleeve 92 provided with an opening 102 in which an attachment member 100 shaped as a string is fixed.

In the distal end, a U-shaped holding element configured to receive a paw is provided, so that a dog can displace that part of the device 2 that is arranged in the sleeve 92 along the longitudinal axis X of the device 2.

FIG. 8B shows a schematic illustration of the device 2 shown in FIG. 8A in another more open configuration, wherein that part of the device 2 that is arranged in the sleeve 92 has been displaced along the longitudinal axis X of the device 2. Accordingly, four overlap members 74, 76, 78, 80 are visible.

Each of the four overlap members 74, 76, 78, 80 is attached to the underlying structure (fabric) by means of a loop and hook fastener attachment.

FIG. 8C shows a schematic view of the device 2 shown in FIG. 8A and FIG. 8B in a third even further open configuration in which the first overlap member 74 has been released from the underlying structure in such a manner that the attachment member 14 is detached from the attachment member 16 and that the tidbit 4 is accessible.

The device 2 is suitable for stimulating and training e.g., dogs that are challenged cognitively by using the device 2. In order to gain access to a tidbit 5, the dog initially needs to place a paw in the holding member 99, and hereafter the dog needs to pull the central portion of the device 2 along the longitudinal axis X of the device 2 in order to expose the members 74, 76, 78, 80. When the members 74, 76, 78, 80 are accessible, the dog subsequently needs to maintain the members 74, 76, 78, 80 in an accessible position and at the same time pull one or more of the flaps 12, 12′, 12″, 12′″ in order to get access to the underlying tidbit 4.

It is possible to provide a device that comprises a number of sub devices like illustrated in the drawings. In this manner, it is possible to stimulate and train dogs and increase the level of difficulty in such a manner that the dog is stimulated concurrently with the skills of the dog being improved.

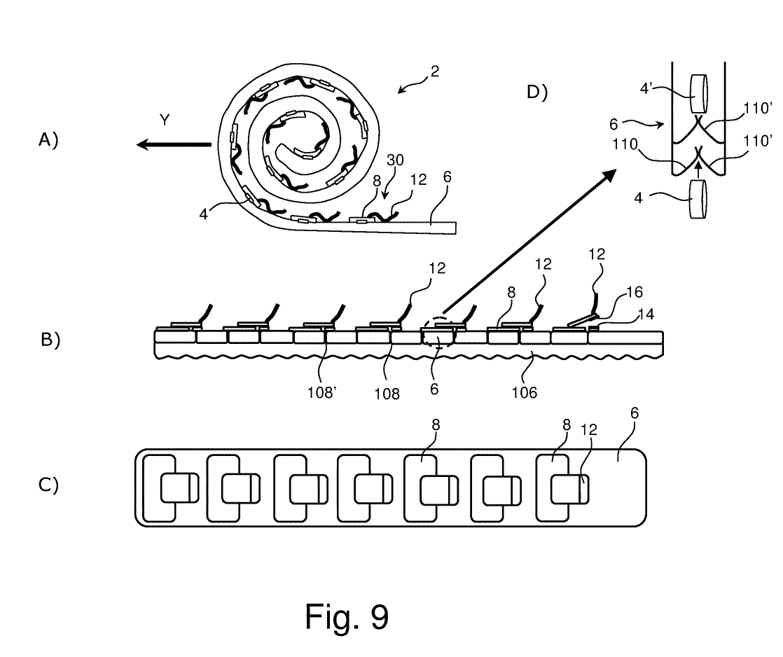

FIG. 9 shows a schematic illustration of a device 2 according to the invention in a first rolled up configuration. The device 2 comprises a collapsible bottom portion 6 onto which a number of top portions 8 are attached. The bottom portion 6 and the top portions 8 are arranged in such a manner that a tidbit 4 can be arranged between the bottom portion 6 and the bottom side of the top portion 8. The tidbit 4 is retained by means of a flap 12 attached to the top portion 8. The flap 12 is adapted to be attached to the bottom portion 6 by means of a loop and hook fastener or another attachment member (e.g., magnetism buttons or band). The flap 12 constitutes an attachment member 30 like the one shown in FIG. 1C-E.

The bottom portion 6 is made in a material that makes the device 2 roll up. The bottom portion 6 may be made in an elastic or flexible material or by a piece of fabric to which flexible structures extending along the longitudinal axis of the device are attached.

A dog can have access to the tidbits 4 by holding the outermost distal end of the bottom portion 6 by stepping/standing on it and thereafter roll the device out by pushing the remaining portion of the device 2 along the direction Y. When a flap 12 is visible, the dog can pull the flap 12 and detach the flap 12 form the bottom portion 6 and hereby get access to the tidbit 4.

FIG. 9B shows a side view of a device 2 of the type shown in FIG. 9A. The device 2 is, however, slightly shorter that the device shown in FIG. 9A. The device 2 comprises a bottom portion 6 in which a number of stitching/hems are provided in order to segment the bottom portion 6 and hereby make it easier to roll up the device 2.

A base member 106 is attached to the bottom side of the bottom portion 6.

Along the top side of the bottom portion 6, a number of top portions 8 are attached. The top portions 8 are connected to a flap 12 that is configured to be attached to the bottom portion by means of corresponding pieces of loop and hook fasteners 14, 16.

FIG. 9C shows a top view of one of the devices shown in FIG. 9B. It can be seen in FIG. 9C that the top portions 8 are evenly distributed along the bottom portion 6, and that the flaps 12 are symmetrically arranged on the top portions 8.

FIG. 9D shows a close-up view of how a tidbit 4, 4′ can be arranged in a pocket in the bottom portion 6 in an easy and user-friendly manner. The pocket in the bottom portion 6 is configured to receive tidbits 4, 4′. The pocket in the bottom portion 6 comprises pairwisely (one-way arranged) locking members 110, 110′ that preferably are made in a flexible material. By applying a flexible material, the device returns to its initial configuration shown in FIG. 9D. At the same time, the material allows for placing a tidbit between the locking members 110, 110′.

The advantage of applying a device corresponding to the one shown in FIG. 9D is that it is possible to arrange tidbits 4, 4′ in the bottom portion 6 without rolling it out initially. It is an advantage to insert tidbits 4, 4′ in this manner due to the fact that one does not have to touch the portions the dog has been chewing on (which may be wet and disgusting).

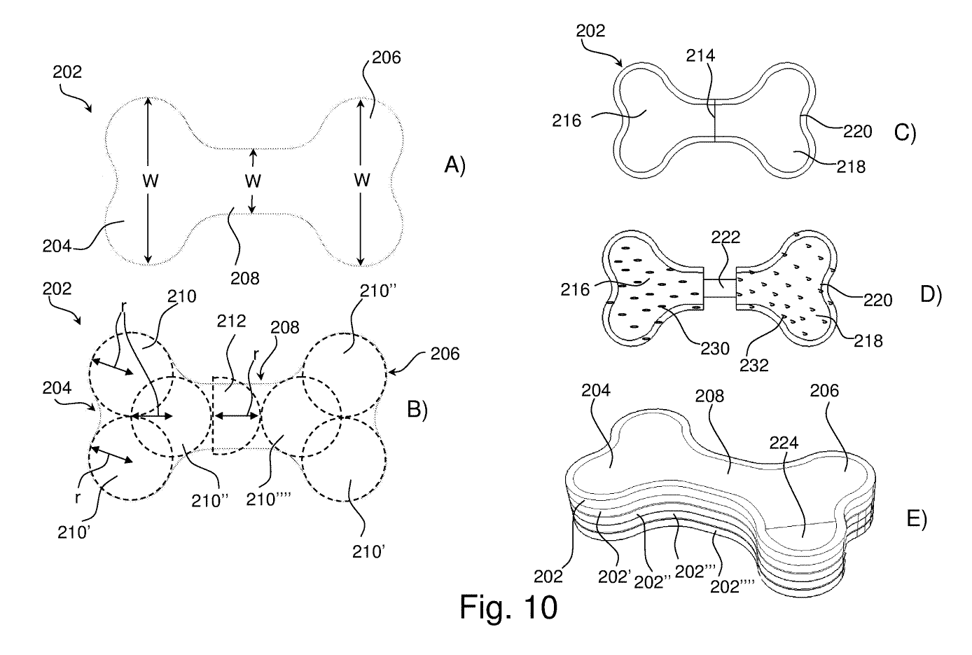

FIG. 10A shows a schematic top view of a connection member 202 according to the invention. The connection member 202 comprises a central body portion 208, a first body portion 204 and a second body portion 206. The central body portion 208 extends between the first body portion 204 and the second body portion 206. The width W′ of the first body portion 204 and the width W″ of the second body portion 206 is larger than the width W of the central body portion 208. When the first body portion 204 and the second body portion 206 are used for attachment, it may be an advantage that the widths W′, W″ are large.

In FIG. 10B, it can be seen that the geometry of the connection member 202 is based on six identical sized circular structures 210, 210′, 210″, 210′, 210″″, 210′″″ and one semi-circular structure 212 indicated with dotted lines. The first body portion 204 is constructed in a manner in which it contains two identical circular structures 210, 210′ placed next to each other and one circular structure 210″ of similar size arranged in equal distance from the two identical circular structures 210, 210′. The distance between the center of the circular structure 210″ and the intersection point of the two identical circular structures 210, 210′ corresponds to the radius of the identical sized circular structures 210, 210′, 210″, 210′″, 210″″, 210′″″.

The connection member 202 is symmetric and comprises an elongated central body portion 208 extending between the first body portion 204 and the second body portion 206. The central body portion 208 has a length corresponding to three times the radius r.

FIG. 10C illustrates a top view of a partitioned connection member 202 according to the invention in a closed configuration. The connection member 202 comprises a first portion 216 and second portion 218. The first portion 216 is a separate member attached to each other by means of a flexible member 222 as illustrated in FIG. 10DB. The first portion 216 and the second portion 218 are configured to be separated from each other. However, in FIG. 10C, the first portion 216 and the second portion 218 are brought into contact with each other. The contact area is indicated by a joint line 214.

A stitching 220 is provided along the periphery of the connection member 202. The connection member 202 may preferably comprise a layer constructed in leather, fabric or a plastic material. The connection member 202 comprises at least one attachment area configured to be attached to a receiving structure.

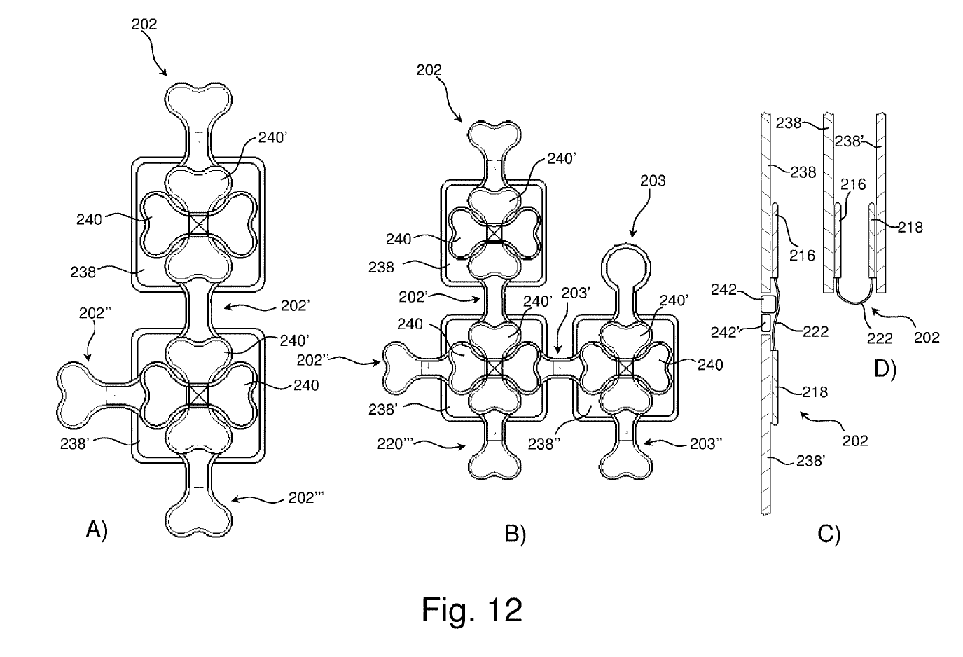

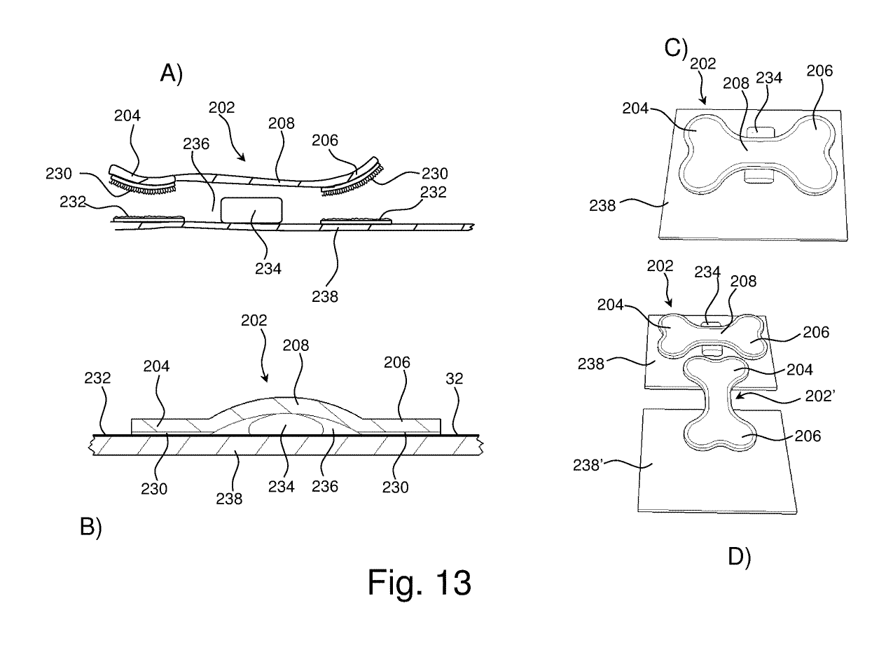

FIG. 10D illustrates another view of the connection member 202 shown in FIG. 10C. In FIG. 10D, the opposite side of the connection member 202 can be seen. As illustrated in FIG. 10D, the connection member 202 comprises a first portion 216 and second portion 218 connected to each other by means of a flexible member shaped as an elastic band 222. The first portion 216 comprises a first type of attachment members 230, whereas the second portion 218 comprises a second type of attachment members 232. In one embodiment according to the invention, the first type of attachment members 230 and the second type of attachment members 232 may be different and be configured to be attached to each other or to receiving structures (see FIG. 12 and FIG. 13). In another embodiment according to the invention, the first type of attachment members 230 and the second type of attachment members 232 may be of equal type and be configured to be attached to receiving structures (see FIG. 12 and FIG. 13). Due to the flexible member shaped as an elastic band 222, the connection member 202 can be used to attach structures of various types of geometry (see FIG. 12C).

FIG. 10E illustrates five connection members 202, 202′, 202″, 202′″, 202′″ arranged on top of each other. The uppermost connection member 202 comprises a first head portion 204, a second head portion 206 and a central body portion 208 provided there between. The uppermost connection member 202 furthermore comprises an attachment free area 224 provided in the corner region of the second head portion 206. The connection members 202, 202′, 202″, 202′″, 202″″ are attached to the adjacent connection members 202, 202′, 202″, 202″, 202″ by means of attachment members attached to the abutting sides of the adjacent connection members 202, 202′, 202″, 202′″, 202″″. The attachment means may be hook and loop fasteners.

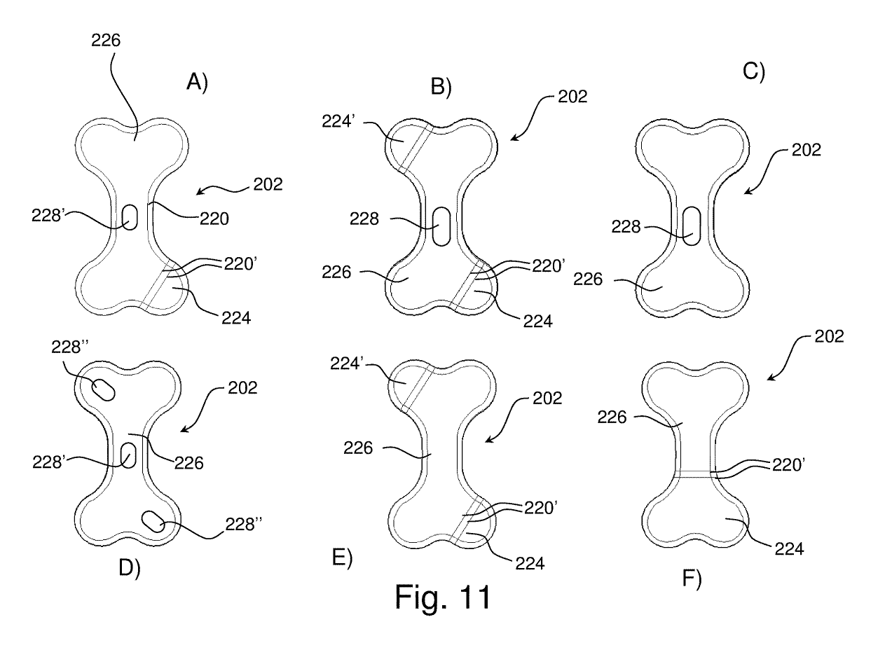

FIG. 11A illustrates a connection member 202 provided with an attachment free corner area 224 like the connection member 202 shown in FIG. 10E. The connection member 202 comprises an attachment side 226 provided with attachment means configured to be attached to a receiving structure. The attachment means are hook or loop fasteners. The connection member 202 is provided with a stitching extending along the periphery of the connection member 202. The connection member 202 is provided with an additional stitching 220′. When the connection member 202 is attached to a receiving structure, the connection member 202 is accessible due to the attachment free corner area 224 that is not fixed to the receiving structure. Accordingly, the connection member 202 may be removed by pulling the attachment free corner area 224.

A central attachment free area 228′ is provided in the central portion of the connection member 2. The central attachment free area 228′ may be a through-going hole in order to achieve as much space as possible to hide an object (e.g., a titbit). It may be an advantage to have a central attachment free area 228′ formed as a through-going hole if the central portion of the connection member 2 is covered by another element (e.g., another connection member or another structure).

FIG. 11B illustrates a connection member 202 provided with an attachment area 226, two attachment free corner areas 224, 224′ and a central attachment free area 228. When this connection member 202 is attached to a receiving structure, a tidbit (not shown) may be placed below the central attachment free area 228. Moreover, the connection member 202 may be removed by pulling one of the attachment free corner areas 224, 224′. The attachment area 226 is provided with hook or loop fasteners.

FIG. 11C illustrates a connection member 202 provided with an attachment area 226 provided with hook or loop fasteners and a central attachment free area 228.

FIG. 11D illustrates the opposite side of the connection member 202 shown in FIG. 11A. The opposite side (top side) comprises an attachment area 226 provided with hook or loop fasteners. Accordingly, both the top surface and bottom surface of the connection member 202 is configured to be attached to receiving structures. In another embodiment according to the invention, the connection member 202 comprises a top side without attachment structures. The top side may be made in leather or fabric.

A central attachment free area 228′ is provided in the central portion of the connection member 2. A first attachment free area 228″ is provided in a first end of the connection member 2. Likewise, a second attachment free area 228″ is provided in the opposite end of the connection member 2. The central attachment free areas 228′, 228″ may be formed as a through-going hole to achieve a large storage to hide an object (e.g., a tidbit). A central attachment free area 228′, 228″ formed as a through-going hole may be an option if the central portion of the connection member 2 is covered by another element (e.g., another connection member or another structure).

FIG. 11E illustrates the opposite side (top side) of the connection member 202 shown in FIG. 11B. The opposite side (top side) comprises an attachment area 226 provided with hook or loop fasteners. Therefore, both the top surface and bottom surface of the connection member 202 is configured to be attached to receiving structures. The connection member 202 comprises two attachment free corner areas 224, 224′ and stitching 220′ provided between the attachment free corner areas 224, 224′ and the attachment area 226.

In another embodiment according to the invention, the connection member 202 comprises a top side without an attachment structure. The top side may be a single large attachment free area made in leather or fabric.

FIG. 11F illustrates a connection member 202 comprising an attachment area 226 and an attachment free area 224. Stitching 220″ is provided between the attachment area 226 and an attachment free area 224.

FIG. 12A illustrates how two structures 238, 238′ are connected by means of a connection member 202′ according to the invention. The first structure 238 comprises a basically square plate-shaped member. A first connection member 240′ has been stitched onto the first structure 238. A second connection member 240 has been stitched onto the first structure 238 and the first connection member 240′.

A connection member 202 is attached to the first connection member 240′. The connection member 202′ is attached to the first structure 238 and to a second structure 238′. The first connection member 240′ is attached to the top surface of the connection member 202′.

The second structure 238′ comprises abasically square plate-shaped member. A first connection member 240′ has been stitched onto the second structure 238′. A connection member 240 has been stitched onto the second structure 238′ and the first connection member 240′.

The connection member 202′ is attached to the second structure 238′ and the first connection member 240′ is attached to the top surface of the connection member 202′. A connection member 202″ is attached to the second structure 238′ and the connection member 240 is attached to the top surface of the connection member 202″. A connection member 202′″ is attached to the second structure 238′ and the connection member 240′ is attached to the top surface of the connection member 202′″.

FIG. 12B illustrates how three structures 238, 238′, 238″ are connected by means of connection members 202′, 203′ according to the invention.

FIG. 12B illustrates an example corresponding to the one shown in FIG. 12A; however, a third structure 238″ is connected to the second structure 238′ by means of a connection member 203′. The connection member 203′ is attached to the second structure 238′ and the connection member 240 of the second structure 238′ is attached to the top surface of the connection member 203′. The connection member 203′ is attached to the third structure 238″ and the connection member 240 of the third structure 238″ is attached to the top surface of the connection member 203′.

A connection member 203 comprises a basically circular head portion and thus it is slightly different from the other connection members 202, 202′, 202″, 202″, 203′, 203″. The connection member 203 is attached to the third structure 238″, and the connection member 240′ of the third structure 238″ is attached to the top surface of the connection member 203. A connection member 203″ is attached to the third structure 238″ and the connection member 240′ of the third structure 238″ is attached to the top surface of the connection member 203″.

FIG. 12C illustrates a cross-sectional view of a connection member 202 according to the invention. The connection member 202 comprises a first portion 216 and a second portion 218 connected by a flexible member 222 provided as an elastic band. The first portion 216 of the connection member 202 is attached to a first structure 238, whereas the second portion 218 of the connection member 202 is attached to a second structure 238′. Two objects 242, 242′ are provided under the elastic band 222.

FIG. 12D illustrates a cross-sectional view of the connection member 202 shown in FIG. 12C in another configuration. The elastic band 222 has been bent in order to use the connection member 202 for connecting the first portion 216 of the connection member 202 to the first structure 238 and for attaching the second portion 218 of the connection member 202 to the second structure 238′.

The use of a flexible member (elastic band 222) provides a large degree of design freedom. Therefore, the connection member 202 makes it possible to connect a large range of structures of a different type, size and geometry. Besides, the connection member 202 allows for connection of structures that are arranged in various positions relative to each other.

FIG. 13A illustrates a cross-sectional view of a connection member 202 according to the invention being attached to an underlying structure 238. The underlying structure 238 is provided with attachment members 232 for receiving corresponding attachment member 230 provided on the connection member 202. A tidbit 34 is arranged in the space 236 between the connection member 202 and the structure 238. The tidbit 234 is arranged between the attachment members 232 on the structure 238.

The connection member 202 comprises a central body portion 208 extending between a first head portion 204 and a second head portion 206. The first head portion 204 and the second head portion 206 are provided with an attachment member 230. The attachment member 230 attached to the first head portion 204 and the second head portion 206 are formed as hooks, whereas the attachment members 232 on the structure 238 are formed as loop fasteners configured to receive the hooks attached to the first head portion 204 and the second head portion 206.

FIG. 13B illustrates a top view of a connection member 202 attached to an underlying structure 238. The connection member 202 comprises a central body portion 208 extending between a first head portion 204 and a second head portion 206. The first head portion 204 and the second head portion 206 are provided with an attachment member 230. The attachment member 230 attached to the first head portion 204 and the second head portion 206 are attached to the attachment member 232 of the underlying structure 238.

The underlying structure 238 is provided with an attachment member 232 for receiving the corresponding attachment members 230 provided on the connection member 202. A tidbit 234 is arranged in the space 236 between the connection member 202 and the structure 238. The tidbit 234 is arranged between the attachment members 230.

FIG. 13C illustrates a perspective top view of a connection member 202 attached to an underlying basically planar structure 238. The connection member 202 is applied to fix a tidbit 234 between the connection member 202 and the structure 238. The connection member 202 comprises a central body portion 208 extending between a first head portion 204 and a second head portion 206. The first head portion 204 and the second head portion 206 are provided with an attachment member attached to the structure 238.

FIG. 13D illustrates a perspective top view of a connection member 202 attached to a first structure 238 and another connection member 202′ connecting the first structure 238 and a second structure 238′. The connection member 202 fixes a tidbit 234 between the connection member 202 and the structure 238 like shown in FIG. 13C. The connection member 202 comprises a central body portion 208 that extends between a first head portion 204 and a second head portion 206 provided with an attachment member attached to the structure 238.

The connection member 202′ is attached to the first structure 238 and to the second structure 238′. Accordingly, the first structure 238 and the second structure 238′ are connected to each other by means of the connection member 202. The attachment is provided by means of hook and loop fasteners.

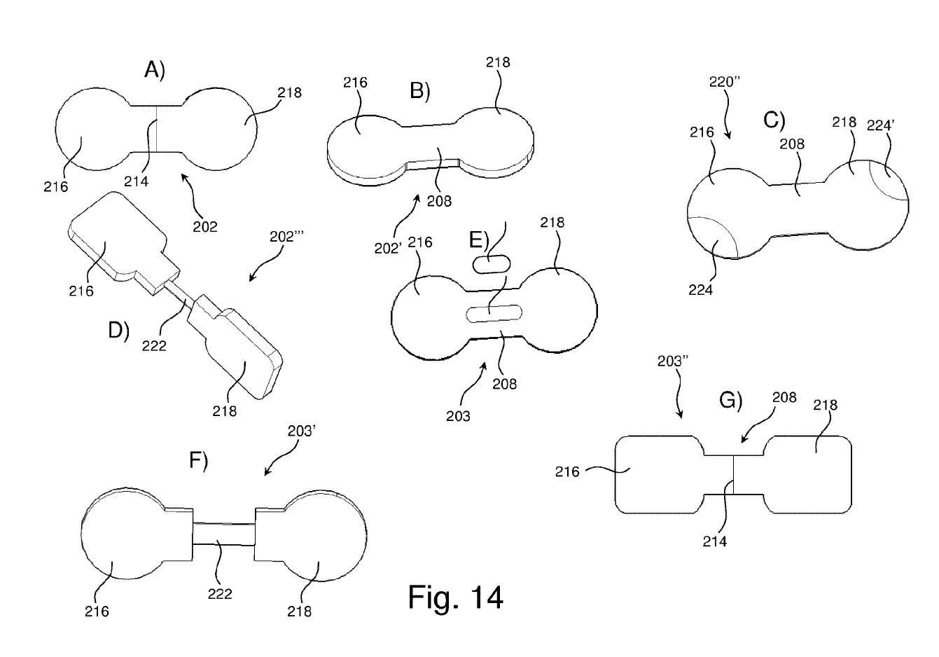

FIG. 14A illustrates a top view of a partitioned connection member 202 according to the invention in a closed configuration. The connection member 202 comprises a first portion 216 and second portion 218 each having a circular geometry. The first portion 216 is a separate member attached to a second portion 218 by means of a flexible member (not shown). The first portion 216 and the second portion 218 are configured to be separated from each other. In FIG. 14A, however, the first portion 216 and the second portion 218 are brought into contact with each other. The contact area is indicated by a joint line 214. The connection member 202 may preferably comprise a layer constructed in leather, fabric or a plastic material. The connection member 202 comprises at least one attachment area configured to be attached to a receiving structure.

FIG. 14B illustrates a perspective view of a connection member 202′ according to the invention. The connection member 202′ comprises a first portion 216 and second portion 218 each having a circular geometry. The connection member 202′ comprises an elongated central body portion 208 extending between the first portion 216 and the second portion 218.

FIG. 14C illustrates a connection member 202″ provided with attachment free areas 224, 224′. The connection member 202 comprises a first portion 216 and second portion 218 each having a circular geometry. The connection member 202″ comprises an elongated central body portion 208 extending between the first portion 216 and the second portion 218. The attachment free areas 224, 224′ are provided in opposite ends of the connection member 202″. The remaining portion of the connection member 202″ may be provided with attachment structures.

FIG. 14D illustrates a perspective view of a connection member 202′ having a first portion 216 and a second portion 218 connected by a flexible member 222. Accordingly, the first portion 216 and the second portion 218 can be displaced and rotated (twisted) relative to each other.

FIG. 14E illustrates a connection member 203 provided with a central attachment free area 228. The connection member 203 comprises a first portion 216 and second portion 218 each having a circular geometry. The connection member 203 comprises an elongated central body portion 208 extending between the first portion 216 and the second portion 218. The connection member 203 can be applied to fix a tidbit between the connection and a structure to which the connection member is attached by means of attachment structures attached to the first portion 216 and the second portion 218.

FIG. 14F illustrates a connection member 203′ like the one shown in FIG. 14A. The connection member 203′ has a first portion 216 and a second portion 218 connected by a flexible member 222 (e.g., a rubber band). Attachment structures are attached to the first portion 216 and the second portion 218 so that the first portion 216 and the second portion 218 is configured to be attached to a structure having a corresponding structure.

FIG. 14G illustrates a connection member 203″ divided into a first portion 216 and a second portion 218. The connection member 203″ corresponds to the connection member shown in FIG. 14D; however, in a closed configuration. The connection member 202 comprises a first portion 216 and second portion 218 each having a basically rectangular cross-sectional geometry. The first portion 216 is a separate member attached to a second portion 218 by means of a flexible member (not shown). The first portion 216 and the second portion 218 are configured to be separated from each other like illustrated in FIG. 14D. In FIG. 14G, however, the first portion 216 and the second portion 218 are brought into contact with each other. The contact area is indicated by a joint line 214. The connection member 202 may preferably comprise a layer constructed in leather, fabric or a plastic material. The connection member 203″ comprises at least one attachment area configured to be attached to a receiving structure.

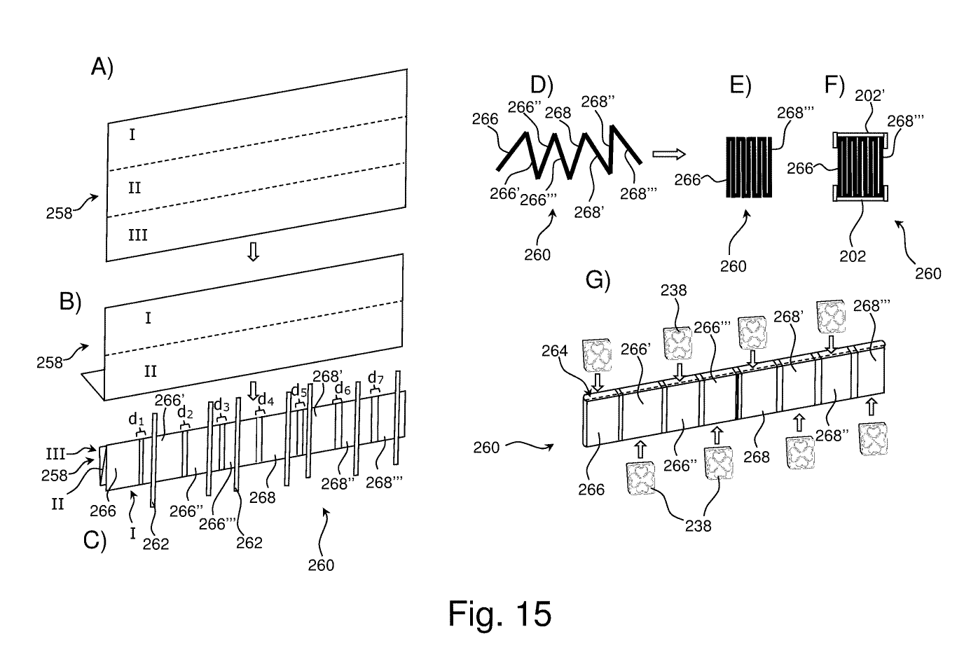

FIG. 15A illustrates a perspective view of a rectangular fabric 258 divided into three equal sized areas I, II, III.

FIG. 15B illustrates a perspective view of the fabric 258 shown in FIG. 15A in a configuration in which the third area III is folded.

FIG. 15C illustrates a perspective view of the fabric 258 shown in FIG. 15B in a configuration in which the third area III and the second area II are folded. Moreover, a number of ribbon members 262 are attached to the fabric 258.

The three layers I, II, III are stitched together to form a number of sections 266, 266′, 266″, 268, 268′, 268″. A joint made by stitching is provided between each adjacent set of sections. The width d₁ of the first joint between the first section 266 and the second section 266′ is smaller than the width d₂ of the joint between the second section 266′ and the third section 266″. Likewise, the width d₂ of the second joint between the second section 266′ and the third section 266″ is smaller than the width d₃ of the joint between the third section 266″ and the fourth section 266″. Similarly, the width d₃ of the third joint between the third section 266″ and the fourth section 266′″ is smaller than the width d₄ of the joint between the fourth section 266′″ and the fifth section 268. Likewise, the width d₄ of the fourth joint between the fourth section 266′″ and the fifth section 268 is smaller than the width d₅ of the joint between the fifth section 268 and the sixth section 268′. Similarly, the width d₅ of the fifth joint between the fifth section 268 and the sixth section 268′ is smaller than the width d₆ of the joint between the sixth section 268′ and the seventh section 268″. Likewise, the width d₆ of the sixth joint between the sixth section 268′ and the seventh section 268″ is smaller than the width d₇ of the joint between the seventh section 268″ and the eighth section 268′″. Accordingly, it is possible to fold the fabric 258 in a manner in which the sections 266, 266′, 266″, 266″, 268, 268′, 268″, 268′″ can be kept flat (no bending occurs). In mathematical terms this reads: d₁<d₂<d₃<d₄<d₅<d₆<d₇.

FIG. 15D illustrates a schematic view of a training device 260 made out of the sections 266, 266′, 266″, 266′, 268, 268′, 268″, 268′″ shown in FIG. 15C. The sections 266, 266′, 266″, 266′″, 268, 268′, 268″, 268′″ are being put together.

In FIG. 15E, the sections 266, 266′, 266″, 266″, 268, 268′, 268″, 268′″ are put together to constitute a training device 260 shaped as a compact and closed member.

In FIG. 15F, a first connection member 202 and a second connection member 202′ are attached to the training device 260 to keep it locked. The connection members 202, 202′ are attached to the training device 260 by means of corresponding hook and loop fasteners provided on the connection members 202, 202′ and on the training device 260.

When the training device 260 is in the closed configuration shown in FIG. 15F, the training device 260 may be used to train or stimulate a dog. The dog will have to spend a long time removing the connection members 202, 20′ and to get the tidbits hidden in the training device 260. This will be explained in further detail with reference to the FIG. 15G.

FIG. 15G illustrates a perspective view of the training device 260 shown in FIG. 15D, FIG. 15E and FIG. 15F. It can be seen that the training device 260 comprises a number of pockets 264 configured to receive structures 238 as illustrated in FIG. 6A, FIG. 6B and FIG. 6D. A structure 238 can be received by the pockets 264 provided in each section 266, 266′, 266″, 266′″, 268, 268′, 268″, 268″. As illustrated in FIG. 15G, the structure 238 has to be inserted from the top in the sections 266, 266″, 268, 268″ and from the bottom in sections 266′, 266″, 268′, 268′″.

When structures 238 have been inserted into the pockets 264, the training device 260 can be folded and locked as illustrated in FIG. 15D, FIG. 15E and FIG. 15F. When tidbits are hidden in the structures 238 and the structures structure 238 are received by the pockets 264 and the training device 260 can be folded and locked, the training device can keep a dog busy for a very long time.

1-15. (canceled)

16. A device for training and stimulation of dogs, comprising:
a square plate-shaped member and
a flat flexible first connection member, the first connection member comprising a central body portion and a first and second head portion connected to opposite ends of the central body portion,
wherein the first connection member has a thickness; and wherein the first and second head portion each have widths larger than the width of the central body portion for the first connection member creating an overall shape resembling that of a dog bone;
wherein both head portions and the square plate-shaped member have cooperating hook and loop fasteners for detachable attachment of both head portions to the square plate-shaped member;
wherein a tidbit receiving space is provided between the first connection member and the square plate-shaped member for containing a tidbit, the tidbit being accessible only if the first head portion is detached from the square plate-shaped member by opening corresponding hook and loop fasteners.

17. A device according to claim 16, wherein a second connection member is provided which is identical to the first connection member and is arranged on the square plate-shaped member perpendicular to the first connection member; wherein the central portion of the first connection member is fixed on the square plate-shaped member by stitches, and wherein a central portion of the second connection member is fixed onto the square plate-shaped member and onto the first connection member by stitches; wherein both head portions of the first and the second connection members and the square plate-shaped member correspondingly comprises cooperating hook and loop fasteners for detachable attachment of both head portions of the first and second connection member to the square plate-shaped member.

18. A device according to claim 17, wherein a fabric is provided under the connection members for placing of dog food thereon.

19. A device according to claim 17, wherein the device further comprises a further connection member having the same shape as the first connection member; wherein a first head portion of the further connection member is sandwiched between the square plate-shaped member and the head portion of the first connection member by detachable attachment by hook and loop fasteners to the square plate-shaped member and the first head portion of the first connection member.

20. A device according to claim 19, wherein the device comprises a further square plate-shaped member and the second head of the further connection member is detachably attached to the further square plate-shaped member by hook and loop fasteners in order to connect the square plate-shaped member to the further square plate-shaped member by the further connection member.

21. A device according to claim 16, wherein the device further comprises a further square plate-shaped member and a further connection member having the same shape as the first connection member; wherein the square plate-shaped member and the further square plate-shaped member are connected to each other by the further connection member; and wherein the heads of the further connection member are detachably attached by hook and loop fasteners to the first and second square plate-shaped member, respectively.

22. A device according to claim 16, wherein the first and second head portions comprise an attachment-free area at a peripheral area thereof for easy access by a dog.

23. A device according to claim 22, wherein the head portions comprise an attachment-free corner area for easy access by the dog and a stitching between the attachment-free corner area and the attachment area.

24. A device according to claim 16, wherein the device comprises a further square plate-shaped member and a further connection member; the further connection member comprising an elastic band as a central body portion and a first and second head portion connected to opposite ends of the central body portion, wherein the first connection member has a thickness; and wherein the first and second head portion each have widths larger than the width of the central body portion for the first connection member creating an overall shape resembling that of a dog bone; wherein the first head portion of the further connection member and the square plate-shaped member comprise cooperating hook and loop fasteners for detachable attachment of the first head portion to the square plate-shaped member; and wherein the second head portion of the further connection member and the further square plate-shaped member comprise cooperating hook and loop fasteners for detachable attachment of the second head portion to the square plate-shaped member; and wherein the square plate-shaped member and the further square plate-shaped member are connected to each other by the further connection member.

25. A device according to claim 24, wherein the elastic band is bent and the square plate-shaped member and the further square plate-shaped member are oriented face-to-face in parallel.

26. A device according to claim 16, wherein the first head portion and the second head portion are shaped as flat structures having a constant thickness.

27. A device according to claim 25, wherein the thickness of the central body portion and of the first and second head portions are identical.

28. A device according to claim 16, wherein the first connection member only has hooks or loops for a hook and loop fastener on one side.

29. A device according to claim 16, wherein the first connection member is made of leather or fabric and is provided with hooks or loops for a hook and loop fastener.

30. A device according to claim 16, wherein the device further comprises a plurality of additional square plate-shaped members and a plurality of additional connection members, each additional connection member having the same shape as the first connection member; the square plate-shaped member being connected to the plurality of additional square plate-shaped members by the additional connection members, wherein the first head of each additional connection members is attached to the square plate-shaped member by hook and loop fasteners and the second head of the additional connection members is attached to one of the plurality of additional square plate-shaped member by hook and loop fasteners.
